(19) United States
(12) Patent Application Publication
(10) Pub. No.: US 2017/0207653 A9
(43) Pub. Date: Jul. 20, 2017

(54) SYSTEM, METHOD, AND APPARATUS FOR PROVIDING TEMPORARY POWER TO A POWER-OVER-ETHERNET LIGHTING NETWORK

(71) Applicant: James A. Kavanagh, Lindenhurst, NY (US)

(72) Inventor: James A. Kavanagh, Lindenhurst, NY (US)

(21) Appl. No.: 14/877,524

(22) Filed: Oct. 7, 2015

Related U.S. Application Data
(60) Provisional application No. 62/060,909, filed on Oct. 7, 2014.

(51) Int. Cl. H02J 9/04; H05B 37/02

(52) U.S. Cl. CPC H02J 9/04; H05B 37/0263; H05B 37/0254

(57) ABSTRACT

The present invention relates in general to the provision of system, method and apparatus for providing temporary low voltage power and is useful for providing power for a Power-over-Ethernet (PoE) powered lighting network. The present invention is useful in a building under construction. Advantageously, the inventive technology includes mobile apparatus that is transportable, thus allowing the apparatus to be transported onto a site, used, and transported from a site. Furthermore, the inventive technology beneficially includes equipment for providing conditioned air space within the apparatus.

### CROSS-REFERENCE TO RELATED APPLICATION

This application claims priority from U.S. Provisional Application Ser. No. 62/060,909 filed on Oct. 7, 2014 and which is incorporated by reference in its entirety herein.

### BACKGROUND OF THE INVENTION

### Field of Invention

This invention relates in general to the provision of system, method, and apparatus for temporary power for a Power-over-Ethernet (PoE) powered lighting network.

The process of cleaning and dusting comprises a number of steps. Such steps include, but are not limited to, identifying the item, object, device or surface that needs to be cleaned; determining the tools and cleaning solutions that need to be used to properly clean such items, objects, devices, and surfaces; beginning the cleaning process by wiping the surfaces that need to be cleaned; and terminating the cleaning process once the item, object, device or surface is clean.

Many of the tools used during the process of cleaning and dusting can include brushes, cleaning cloths, sponges, and cleaning gloves. When using a cleaning cloth, one typically clenches and holds such cleaning cloth in hand, to conform it and wrap it around the hand, so as to better wipe the surface that needs to be cleaned; or fold it to create a stiffness and a crease to reach into, under and around the surfaces that need to be cleaned, as well as to expose a proper cleaning surface. Such wrapping and folding, and re-folding, and clenching of the cleaning cloths in hand, wastes a lot of time. Further, it creates a lot of strain on the hand, particularly when cleaning over long periods of time. This in turn can lead to among other things, chronic arthritis in fingers and hands, or carpal tunnel syndrome, which become particularly acute with aging.

Many of the cleaning solutions that can be used to clean the device or object can include ammonia water, vinegar or a solution thereof, lemon juice or a solution thereof, hypochlorite solutions, oils, and so on, depending on the object, depending on the device, and depending on the surface that needs to be cleaned. However, such cleaning solutions more often than not, contain extremely harsh and abrasive chemicals, which are not only destructive to the environment, dehydrate and destroy the skin on the user's hands, should not be breathed in, since they do cause a number of respiratory conditions and ailments, including but not limited to asthma, but can also he destructive even to the items, objects, devices and surfaces on which they are used to clean.

For example, the use of acid or alcali cleaners, including ammonia or vinegar, for minor cleanup is completely contraindicated by most mirror manufacturers, since either substance can attack the front surface and edges as well as the backing of a mirror. In fact so much so that the spraying of these chemicals directly on the surface of the mirror is totally contraindicated. Instead, the use of a cleaning cloth is highly recommended for the clean up of a mirror. Cleaners should be applied directly to a soft, lint-free cloth and then the cloth should be used to wipe the mirror, so that the cleaner is prevented from contacting the edges of the mirror and damaging them.

To deal with some of the problems set forth herein above, a number of cleaning gloves and mitts have been developed. Most of these gloves and mitts feature various modifications and contrivances which have been. added to the glove and mitt and render them bulky and cumbersome to use. However, most of these cleaning gloves and mitts are limited to one or two specific cleaning applications at most. Thus, most professionals still prefer a cleaning cloth over awkward ill-fitted mitts or gloves with limited usage, because the cloth is more adaptable to most cleaning situations; notwithstanding that its use can cause great pain to hands over prolonged periods of use.

Accordingly, there still exists a need for a device that can clean and dust without any harmful chemicals, can cut cleaning time by a significant amount, deliver high cleaning performance with little effort, is machine washable, While simultaneously providing maximum comfort and little fatigue over its long term cleaning and dusting use.

### FEATURES AND OBJECTS OF THE PRESENT INVENTION

Accordingly, a general feature of the present invention is the provision of a system for providing a multipurpose temporary power supply which may be used in the construction industry, which overcomes many of the problems found in the prior art.

A further feature of the present invention is the provision of anti-theft protection.

A further feature of the present invention is the provision of integrated switch racks.

A further feature of the present invention is the provision of being rugged.

A further feature of the present invention is the provision of being portable. A further feature of the present invention is the provision of being lockable. A further feature of the present invention is the provision of being modular.

A further feature of the present invention is the provision of being locatable.

A further feature of the present invention is the provision of an umbilical cord for mains power.

A further feature of the present invention is the provision that multiple units can be centrally managed.

A further feature of the present invention is the provision of conditioned air space internally.

A further feature of the present invention is the provision of WiFi connectivity.

A further feature of the present invention is the provision for location as a service. A further feature of the present invention is the provision of a lighting control interface.

A further feature of the present invention is the provision of a lighting program control interface.

A further feature of the present invention is the provision of a logical circuit control interface.

A further feature of the present invention is the provision of emergency lighting.

A further feature of the present invention is the provision of an uninterrupted power supply (UPS).

A further feature of the present invention is the provision of a battery back-up.

A further feature of the present invention is the provision of a remote kill switch.

A further feature of the present invention is the provision of an external kill switch.

A further feature of the present invention is the provision of an external master control lever.

A further feature of the present invention is the provision of providing a lease option for the unit.

A further feature of the present invention is the provision of a sale option for the unit.

A further feature of the present invention is the provision of a POE device interface using RFID for location and inventory control on the job site.

A further feature of the present invention is the provision of a POE device interface using WiFi.

A further feature of the present invention is the provision of a POE device interface using security cameras.

A further feature of the present invention is the provision of a POE device interface using environmental sensors.

A further feature of the present invention is the provision of a POE device interface using O2/CO2 and other sensors.

A further feature of the present invention is the provision of a POE device interface for access control, such as door swipes.

A further feature of the present invention is the provision of a POE device interface using VOIP.

A further feature of the present invention is the provision of a POE device interface using femto-cells.

A further feature of the present invention is the provision of a POE device interface using monitors, such as touch screens.

A further feature of the present invention is the provision of a POE device interface using monitors to access OSHA regulations.

A further feature of the present invention is the provision of a POE device interface using monitors to access MSDS sheets.

A further feature of the present invention is the provision of a POE device interface using monitors to access training records, etc.

A further feature of the present invention is the provision of an internet connection.

A further feature of the present invention is the provision of a dashboard for displaying performance metrics.

A further feature of the present invention is the provision of a dashboard for displaying energy usage.

### BRIEF DESCRIPTION OF THE DRAWINGS

It is believed that the present invention will be better understood from the following detailed description taken in conjunction with the accompanying drawing, in which the numerals represent identical elements and wherein:

FIG. 1 is an illustration of the system and apparatus used in the present invention.

### PREFERRED EMBODIMENT OF THE PRESENT INVENTION

The present invention relates in general to the provision of system, method, and apparatus for temporary power for a Power-over-Ethernet (PoE) powered lighting network.

In the building construction industry, the electrical contractor is typically responsible for providing temporary construction light, power, and telecom including, but not limited to, lighting and power necessary for various trades to perform their work, power for heat, and often power to various contractor's job offices.

PoE lighting, or Lighting As A Service, is an emerging technology for efficiently lighting buildings, and what is needed is a solution for the electrical contractor to provide temporary Power-over-Ethernet lighting, so that the various trades are able to perform their work.

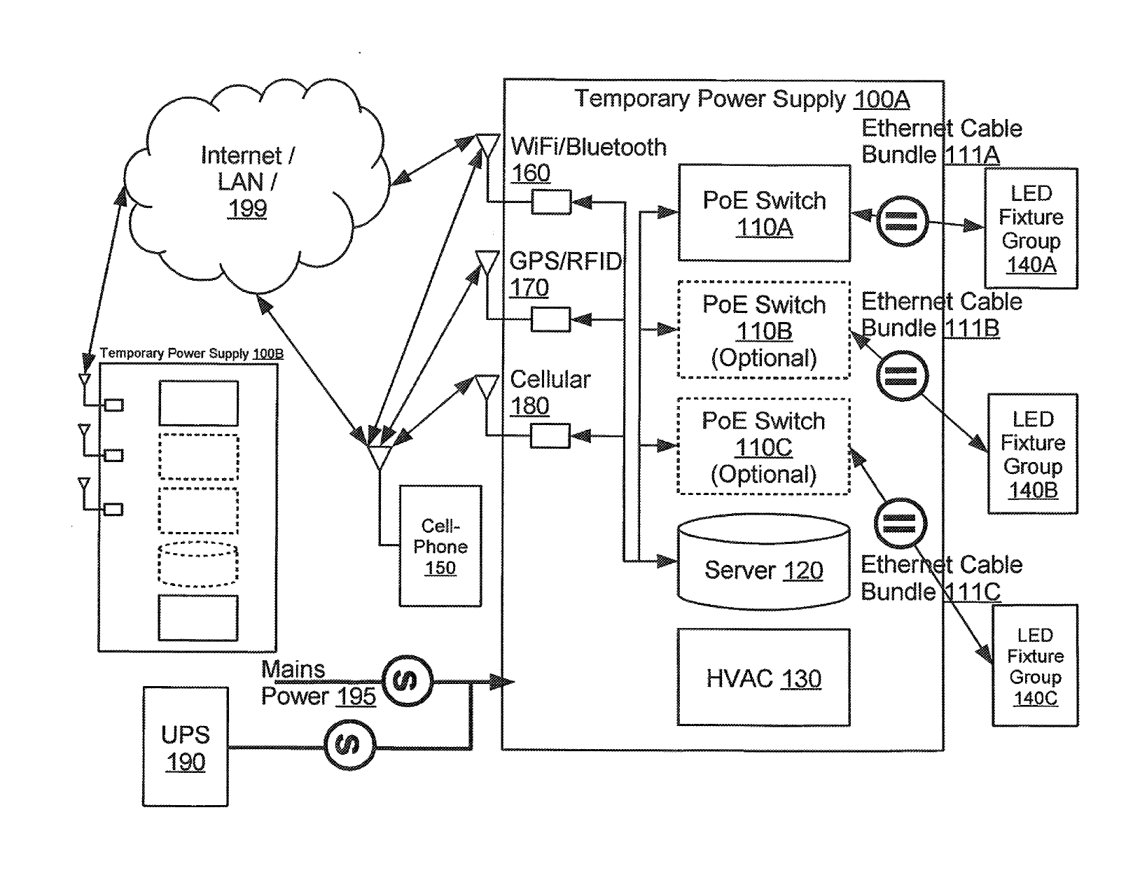

FIG. 1 is a graphical representation of the present invention.

Temporary Power Supply 100A, 1008 is a cabinet that houses all the equipment and systems that are necessary to provide temporary power for a PoE powered lighting system. The cabinet, may include, but is not limited to the following items (not shown): wheels, pockets to receive forklift tongs, lifting eyes, wheels, casters, ventilation slats, fans for ventilation, doors, access panels, quick connect couplings for electrical connections, master disconnect switches, fuses, network equipment racks for switches and servers, interior lights, locks, etc.

Temporary Power Supply 100B is optional. Although, only one optional Temporary Supply Power 100 is illustrated in FIG. 1, there is no limit to the number of Temporary Power Supply 100s that can be used to provide temporary power in a building that is under construction. A plurality of Temporary Power Supply 1OOs can be managed by a single Server 120.

Temporary Power Supply 100A, 100B cabinet may be constructed of materials that include, but are not limited to, metal, plastic, etc.

Temporary Power Supply 100A, 100B is further comprised of the following elements:

PoE Switch 110A, 110B, 100C are commercially available Power-over-Ethernet switches which are designed to pass electrical power along with data on standard Ethernet cabling. This allows a single cable to provide both data connection and electrical power to devices such as, but not limited to, wireless access points, IP cameras, and LED lighting. PoE allows for long cable lengths. Power may be carried on the same conductors as the data, or it may be carried on dedicated conductors in the same cable.

There are several common techniques for transmitting power over Ethernet cabling. Two of them have been standardized by IEEE 802.3. Since only two of the four pairs are needed for 10BASE-T or 100BASE-TX, power may be transmitted on the unused conductors of a cable. In the IEEE standards, this is referred to as Alternative B. Power may also be transmitted on the data conductors by applying a common-mode voltage to each pair. Because twisted-pair Ethernet uses differential signaling, this does not interfere with data transmission. The common mode voltage is easily extracted using the center tap of the standard Ethernet pulse transformer. This is similar to the phantom power technique commonly used for powering audio microphones. In the IEEE standards, this is referred to as Alternative A.

In addition to standardizing existing practice for spare-pair and common-mode data pair power transmission, the IEEE PoE standards provide for signaling between the power source equipment (PSE) and powered device (PO). This signaling allows the presence of a conforming device to be detected by the power source, and allows the device and source to negotiate the amount of power required or available. Up to a theoretical 51 watts is available for a device, depending on the version of the standard in use and the vendor of PoE enabled LED light (not shown), or any PoE enabled device, such as, but not limited to, cameras, VoIP phones, WiFi access points, etc.

PoE Switch 110A, 1108, 110C are under the control of Server 120. Server 120 is is a running instance of an application (Software) capable of accepting request from the client and give response accordingly. Servers can run on any computer or dedicated computer, which is also often referred to as “the server”. In many cases, a computer can provide several services and have several servers running. The advantage of running servers on dedicated computer is security. For this reason most of the servers are daemon processes and designed by the designers in such a way that it can run on specific computer(s).

Typically, PoE Switch 110A, 1108, 110C are rack mounted hardware designed to be installed into a standard rack (not shown) for mounting network and electronic gear, such as, but not limited to switches, servers, routers, hubs, amplifiers, etc.

The network gear (not shown) may be used to allow at least one person to connect to the Internet/LAN 199 via a hardwired connection (not shown), or via a wireless connection, such as, but not limited to WiFi/Bluetooth 160 wireless access point, or Cellular 180 wireless access point, via Cellphone 180. Alternatively, a person could used another device (not shown) to connect to the InterneULAN 199, such as, but not limited to a tablet, laptop, PC, etc.

In addition, the network gear (not shown) may be used to connect Server 120 to GPS/RFID 170 systems that may be used for locating and tracking personnel, inventory, and mobile assets. Also, the network gear (not shown) may be used for connecting to Cellular 180 equipment. This equipment may be, but is not limited to, femto-cells. Femto-cells provide a wireless access point for cellular communications that back-haul over the Internet/LAN 199 to a cellular provider (not shown).

Server 120 operates within a typical client-server architecture. Servers are computer programs running to serve the requests of other programs, the clients. Thus, the server performs some tasks on behalf of clients. The clients typically connect to the server through the network but may run on the same computer. In the context of Internet Protocol (IP) networking, a server is a program that operates as a socket listener.

In general, servers provide essential services across a network, either to private users inside a large organization or to public users via the Internet. Typical computing servers are database servers, file servers, mail servers, print servers, web servers, gaming servers, and application servers.

In the preferred embodiment of the present invention, Server 120 may include software to run the lighting system in a building that is under construction. In addition, Server 120 may include software to run other systems, such as, but not limited to, security systems, VoIP telephones, display monitors, sensors, and Real Time Location Systems (RTLS), WiFi access points, Bluetooth access points, femto-cells, etc.

Server 120 is shown located within Temporary Power Supply 100A, 1008, but alternatively, may be located remotely.

Temporary Power Supply 110A, 1108 also includes (not shown) the necessary network gear to connect Server 120 to Temporary Power Supply 11OA, 1108. The network gear may include, but is not limited to, hubs, routers, switches, firewalls, gateways, etc.

HVAC 130 is air conditioning equipment used for controlling the temperature, humidity, and air quality of the interior space of Temporary Power Supply 100A, 1008.

HVAC 130 in FIG. 1 is illustrated as located within Temporary Power Supply 110A, 1108 cabinet, but alternatively may be outside the cabinet in an adjacent position. in this alternative position, conditioned air is transferred into Temporary Power Supply 110A, 1108 via a duct, such as, but not limited to, a flexible duct of appropriate size.

PoE Switches 110A, 1108, 110C are connected respectively to LED Fixture. Groups 140A, 1408, 140C, via Ethernet cable bundles 111A, 1118, 111C. Ethernet cable bundles 111A, 1118, 111C provide combined data and power on each individual Ethernet cable within Ethernet cable bundles 111A, 1118, 111C to at least one LED Fixture contained within an LED Fixture Group 140A, 1408, 140C.

Ethernet cable bundles 111A, 1118, 111C are constructed of at least one Ethernet cable. The at least one Ethernet cable is constructed to a standard such as, but not limited to, Cat 5, Cat 5e, Cat 6, etc. These Ethernet cables may be required to plenum rated as well. Typically, the at least one Ethernet cable is terminated on both ends with an RJ45 male connector.

Alternatively, the at least one Ethernet cable may be terminated at an intermediate patch panel that is equipped with punch down blocks, and/or RJ45 female connectors. In this alternative, Ethernet jumper cables (not shown) would be required to complete the connection from the patch panel (not shown) to PoE Switch 110A, 1108, 110C.

The at least one Ethernet cable may be configured as a home-run connected to a single LED Light Fixture (not shown) within LED Fixture Group 140A, 1408, 140.

Alternatively, the at least one Ethernet cable may be connected to multiple LED Light Fixtures (not shown) within LED Fixture Group 140A, 1408, 140C that are linked together either in a daisy chain, or a hub and star arrangement.

Temporary power for Temporary Power Supply 110A, 1108, may be provided by UPS 190, or a generator (not shown), in the event Mains Power 195 is interrupted for a period of time.

The present invention meets the needs of electrical contractors on a building site to provide temporary lighting for a PoE powered LED lighting network, and optionally temporary data, and optionally temporary cellular communications during the construction period.

In addition, the present invention can provide Location As A Service for various contractors to track personnel, mobile assets, tools, and inventory using a combination of WiFi, GPS where applicable, and RFID as a Real Time Location System.

Temporary Power Supply 110A. 1108 are modular. These units can be supplied with one, to several PoE Switches. These units can be linked together using a single server. These units can be used to create logical circuits during the construction project, and once the Temporary Power Supply 11OA, 1108 are replaced with permanent PoE Switches, and network gear, these logical circuits can be transferred easily transferred to a permanent Server 120, in order to more easily commission the permanent PoE powered LED lighting network.

Temporary Power Supply 110A, 1108 can be sold, rented, or leased to a general contractor, electrical contractor, or building owner.

Temporary Power Supply 110A, 1108 can become the permanent lighting power supply if the contract permits this.

GPS/RFID 170 Cellular 180 can be used by a back-end computer system to keep track of the location of a rented, or leased Temporary Power Supply 110A, 1108, 110C.

Cellular 180 can be used to disable rented, or leased, Temporary Power Supply 110A, 110B in the event of non-payment.

### OPTIONS. FEATURES, AND BENEFITS

The provision of anti-theft protection.

The provision of integrated switch racks. The provision of being rugged.

The provision of being portable. The provision of being lockable.

The provision of being modular.

The provision of being locatable.

The provision of an umbilical cord for mains power.

The provision that multiple units can be centrally managed. The provision of conditioned air space internally.

The provision of WiFi connectivity.

The provision for location as a service.

The provision of a lighting control interface.

The provision of a lighting program control interface.

The provision of a logical circuit control interface.

The present invention is the provision of emergency lighting.

The provision of an uninterrupted power supply (UPS).

The provision of a battery back-up.

The provision of a remote kill switch.

The provision of an external kill switch.

The provision of an external master control lever.

The provision of providing a lease option for the unit. The provision of a sale option for the unit.

The provision of a POE device interface using RFID for location and inventory control on the job site.

The provision of a POE device interface using WiFi.

The provision of a POE device interface using security cameras.

The provision of a POE device interface using environmental sensors.

The present invention is the provision of a POE device interface using O2/CO2 and other sensors.

The provision of a POE device interface for access control, such as door swipes.

The provision of a POE device interface using VOIP.

The provision of a POE device interface using femto-cells.

The provision of a POE device interface using monitors, such as touch screens.

The provision of a POE device interface using monitors to access OSHA regulations.

The provision of a POE device interface using monitors to access MSDS sheets.

The provision of a POE device interface using monitors to access training records, etc.

The provision of an internet connection.

The present invention is the provision of a dashboard for displaying performance metrics.

The provision of a dashboard for displaying energy usage.

In addition, the attachments to this provisional patent application further describe aspects of various technologies, features, objects, or options that are included in the specification herein.

The present invention has been described in particular detail with respect to several possible embodiments. Those of skill in the art will appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different platforms. Furthermore, the computers referred to in the specification may include a single processor or may be architectures employing multiple processor designs for increased computing capability.

The scope of this invention should be determined by the appended claims and their legal equivalents, rather than by the examples given.

Accordingly, I claim:

1. A system for providing a selected site with temporary power, comprising
mobile apparatus on wheels or casters, capable of providing a selected site with temporary low voltage power, wherein said mobile apparatus comprises (a) connectivity to a main power source, (b) a server, and (c) at least one low voltage switch comprising a plurality of output ports connectable through low voltage cables each capable of passing both electrical power and data, said switch being under the control of said server and in communication with at least one low voltage device capable of receiving and/or transmitting data;
a computer program running on said server for providing two-way communication comprising power control-signaling to and from said at least one low voltage device;
wherein said mobile apparatus further comprises equipment providing the interior space of said mobile apparatus with conditioned air comprising temperature- and humidity-controlled air, wherein said server and said switch are within said interior space.

2. A method for providing a selected site with temporary power, comprising
transporting mobile apparatus onto a selected site, wherein said apparatus is capable of providing a selected site with temporary low voltage power, and said mobile apparatus comprises (a) connectivity to a main power source, (b) a server, (c) at least one low voltage switch comprising a plurality of outlet ports connectable through low voltage cables each capable of passing both electrical power and data, wherein said switch is controllable by said server and is connectable with at least one low voltage device capable of receiving and/or transmitting data; and (d) equipment for providing conditioned air space;
connecting said mobile apparatus to a main power source;
thereafter using said mobile apparatus to provide said site with temporary low voltage power comprising controlling said switch by a computer program running on said server and providing two-way communication comprising power control-signaling to and from said at least one low voltage device, and providing the interior space of said mobile apparatus with conditioned air comprising temperature- and humidity-controlled air, wherein said server and said switch are within said interior space;
disconnecting said mobile apparatus from said main power source; and
transporting said mobile apparatus from said site.

3. Mobile apparatus on wheels or casters for providing a selected site with temporary low voltage power, comprising
(a) connectivity to a main power source, (b) a server, (c) at least one low voltage switch comprising a plurality of outlet ports connectable through low voltage cables each capable of passing both electrical power and data, wherein said switch is controllable by said server and is connectable with at least one low voltage device capable of receiving and/or transmitting data, and (d) equipment for providing the interior space of said mobile apparatus with conditioned air comprising temperature- and humidity-controlled air, wherein said server and said switch are within said interior space; and
a computer program for providing two-way communication comprising power control-signaling to and from said at least one low voltage device.

4. The method of claim 2, wherein said mobile apparatus further comprises wheels or casters, and said transporting of said mobile apparatus comprises wheeling said mobile apparatus onto and from said site.

5. The system of claim 1, wherein said at least one low voltage device is an LED lighting network and said cables are Ethernet cables, for providing said temporary low voltage power for a power-over-Ethernet LED lighting network.

6. The method of claim 2, wherein said at least one low voltage device is an LED lighting network and said cables are Ethernet cables, and said temporary low voltage power is for a power-over-Ethernet LED lighting network.

7. The mobile apparatus of claim 3, wherein said at least one low voltage device is an LED lighting network and said cables are Ethernet cables wherein said switch is connectable with said LED lighting network for providing temporary power for a power-over-Ethernet LED lighting network.

8. The system of claim 1, wherein said mobile apparatus further comprises network gear capable of providing temporary cellular communication.

9. The method of claim 2, wherein said mobile apparatus further comprises network gear capable of providing temporary cellular communication.

10. The mobile apparatus of claim 3, further comprising network gear capable of providing temporary cellular communication.

11. The system of claim 1, wherein said mobile apparatus further comprises network gear capable of providing temporary data connectivity comprising data connectivity to the Internet and/or GPS connectivity and/or RFID connectivity.

12. The method of claim 2, wherein said mobile apparatus further comprises network gear capable of providing temporary data connectivity comprising data connectivity to the Internet, and/or GPS connectivity and/or RFID connectivity.

13. The mobile apparatus of claim 3, further comprising network gear capable of providing temporary data connectivity comprising data connectivity to the Internet, and/or GPS connectivity and/or RFID connectivity.

14. The system of claim 1, wherein said interior space of said mobile apparatus is within a housing provided with ventilation openings.

15. The method of claim 2, wherein said interior space of said mobile apparatus is within in a housing provided with ventilation openings.

16. The mobile apparatus of claim 3, wherein said interior space of said mobile apparatus is within a housing provided with ventilation openings.

17. The system of claim 14, wherein said equipment providing said interior space with conditioned air, is within said housing.

18. The method of claim 15, wherein said equipment providing said interior space with conditioned air, is within said housing.

19. The mobile apparatus of claim 16, wherein said equipment for providing said interior space with conditioned air, is within said housing.
